(19) United States
(12) Patent Application Publication
(10) Pub. No.: US 2016/0261499 A1
(43) Pub. Date: Sep. 8, 2016

(54) Computerized System and Method for Providing Sponsored Internet Access

(71) Applicant: APPLIED RESEARCH WORKS Inc., Palo Alto, CA (US)

(72) Inventor: SHAIBAL ROY, PALO ALTO, CA (US)

(73) Assignee: APPLIED RESEARCH WORKS INC., Palo Alto, CA (US)

(21) Appl. No.: 14/636,213

(22) Filed: Mar. 3, 2015

(51) Int. Cl. H04L 12/741; H04M 15/00; H04L 29/08; H04W 4/24

(52) U.S. Cl. CPC H04L 45/745; H04W 4/24; H04M 15/60; H04L 67/02; H04W 84/12

(57) ABSTRACT

Disclosed is a system and method for providing sponsored internet access. Certain embodiments of the system comprise a network connected to the Internet, one or more servers coupled to the network, a central repository coupled to the one or more servers, a wireless router coupled to the network and a computer readable media encoding instructions for a method of providing sponsored internet access. Certain embodiments of the method for providing sponsored internet access comprise the steps of allowing a user to connect to the network through the wireless router, receiving a request from a user to access a domain, verifying the domain is a sponsored domain, and allowing a user to access the sponsored domain.

### PRIORITY CLAIM

This application is a continuation of, and claims the benefit of U.S. Provisional Application No. 62/004,775 filed on May 29, 2014. The aforementioned application is hereby incorporated by reference.

### BACKGROUND

Presently, there is a demand for internet access from devices that receive data from cellular networks and Wi-Fi hotspots. In some locations wireless internet access is not free and users must pay a fee or perform one or more additional steps (such as make a purchase, supply phone number, or watch promotional video) to access the Internet. In instances where users have access to the internet through a cellular data plan, the data plan is usually limited to a specified volume of data and users may be charged for exceeding their data allowance.

The present invention discloses a computerized system wherein sponsors can provide access to specified websites and internet services to users. Rather than data being purchased by the user, either as part of a data plan or a Wi-Fi hotspot, the sponsor pays a provider of internet services to allow a user to view a webpage or use the sponsor's internet services at no cost to the user and without the data being deducted from a user's data plan allowance.

### BRIEF SUMMARY

The present invention discloses a system that permits users to access the internet through wireless routers. The system determines if a domain a user is attempting to access has sponsored free internet access. If the domain is among the domains the system recognizes as a sponsored domain, the user will be permitted to receive and transmit data with the given domain at no cost to the user.

### BRIEF DESCRIPTION OF THE DRAWINGS

FIG. 1 illustrates an embodiment of a system for providing sponsored internet access.

FIG. 2 illustrates an embodiment of a method for providing sponsored internet access.

### DETAILED DESCRIPTION

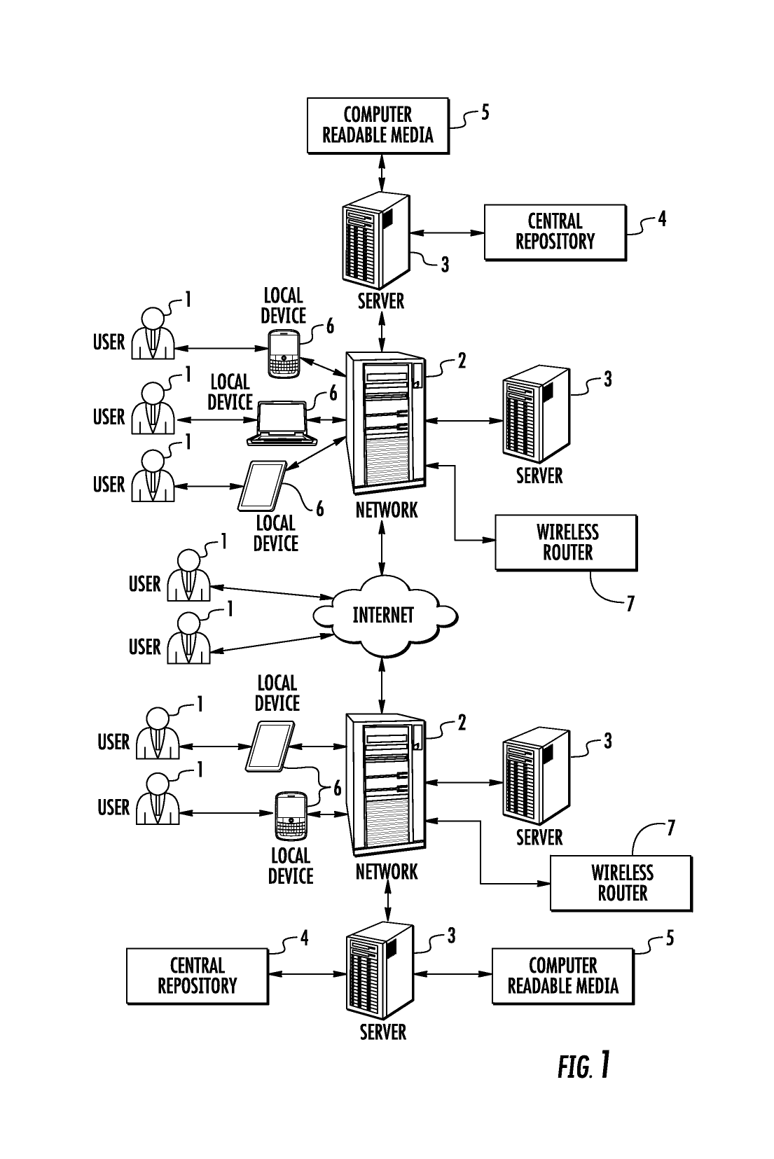

Disclosed is a system and method for providing sponsored wireless Internet access. FIG. 1 illustrates a representative embodiment of the disclosed system. To access the system, each user 1 must be granted access to the system's Internet connection. In certain embodiments, this access may be granted by providing an assigned user name and password. In alternative embodiments, different or additional credentials may be required. In certain embodiments, users will not supply credentials to access the Internet through the system. Instead, access to the Internet access may be granted if the user is accessing certain domains. Users 1 connect to a network 2 through a local device 6. In certain embodiments, users 1 will use their local device 6 to connect to a wireless router 7. In such embodiments, the wireless router is coupled to one or more networks. Alternative embodiments comprise one or networks 2, which may be optionally coupled to the Internet. In certain embodiments, each of the networks 2 will utilize various security features to ensure the security and integrity of the system and data transmitted over the system. In certain embodiments, each network 2 will utilize secure connections (for example, Secure Sockets Layer, Transport Layer Security, or Secure/Multipurpose Internet Mail Extensions). The system comprises one or more servers 3, each server 3 coupled to one or more networks 2. In certain embodiments, one or more servers 3 are coupled to the Internet. In certain embodiments, each server 3 will be protected by one or more firewalls. Further, data on each server may be encrypted. In certain embodiments, non-transitory computer readable media 5 encoding instructions for carrying out various methods is coupled to one or more servers 3. Users connect to the system servers through various devices 6 having connections to one or more networks 2. In alternative embodiments, users may access the system through local area networks, telephonic devices, radio frequencies, computers, or other electronic devices. In certain embodiments, data obtained through, and transmitted over the system resides on one or more central repositories 4. The one or more central repositories 4 may be associated with thin or thick clients where data transmitted through the system will be synchronized. In certain embodiments, all data transmitted and displayed to users resides on the central repository 4.

In some embodiments a user will be provided free access to a Wi-Fi hotspot. In alternative embodiments, a user will be provided access to a website or internet service without data being deducted from the user's cellular data allowance, or charged for using cellular data. In certain embodiments, costs for accessing data will be paid by a sponsor. The sponsor is typically the operator of the website or service, or the organization the website offering goods or services on a website.

In certain embodiments, a prefix will be used as a prefix to the Internet domain name to indicate to users that a website can be accessed for free. Some embodiments will use a prefix commonly associated with toll free phone numbers including, but not limited to as 800, 866, 877, or 888. Additionally, in some embodiments, a “1” may precede the prefix to give the user a more familiar experience, since “1” is commonly dialed before any other number when dialing a toll-free phone number from a telephone.

An example of an embodiment of a domain that would be accessible to a user that offers sponsored access is 800.domain.com, wherein “domain.com” or “www.domain.com” is the usual domain a user would use to access the website. When a user uses such a prefix, a combination of caching and authoritative Domain Name Severs (DNS), either in combination or individually, will determine if sponsored access is available. If sponsored access is available, the website will be displayed to the user, at no cost to the user and without a reduction in the user's data allowance, if applicable. In certain embodiments, if sponsored access is not available, the user will informed of the lack of sponsored access, and may be provided a link to available content that will not be sponsored and may result in a cost to the user.

Domains that are sponsored will be store on the central repository 4. Additionally, computer readable instructions for providing sponsored internet access will reside on computer readable media coupled to one or more servers 3.

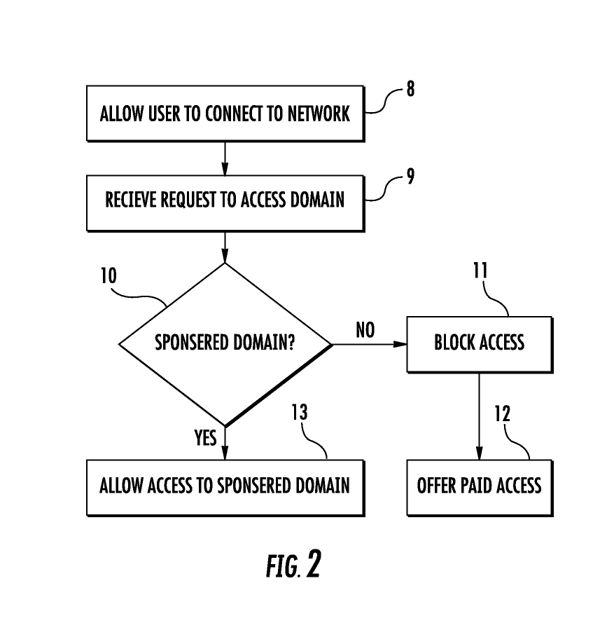

FIG. 2 illustrates an embodiment of a method to provide sponsored internet access to users. First, users will connect to a network 8. In certain embodiments, users will use a local device 6 with wireless capabilities to establish a connection with a wireless router 7 coupled to a network. The system will then receive a request from a user to access a domain 9. Typically, users will use web browsers to access domains, but other software applications may be used to access specific domains. The system will then determine if the domain the user is requesting to access is sponsored 10. A list of sponsored domains is maintained on the central repository 4. If the domain is sponsored, the system will allow access to the domain 13. If the domain is not sponsored, the system will not allow the user to access the requested domain 11. In certain embodiments, a message may be presented to the user offering the user the ability to pay for internet access.

While the invention has been described and illustrated with reference to certain particular embodiments thereof, those skilled in the art will appreciate that the various adaptations, changes, modifications, substitutions, deletions, or additions or procedures and protocols may be made without departing from the spirit and scope of the invention. In particular, those skilled in the art will appreciate that the present invention has utility in multiple settings and industries. Although healthcare applications were disclosed in detail, the application of the present invention is not limited to healthcare. It is intended, therefore, that the invention be defined by the scope of the claims that follow and that such claims be interpreted as broadly as reasonable.

What is claimed is:

1. A system for providing sponsored internet access comprising:
a network connected to the Internet;
one or more servers coupled to the network;
a central repository coupled to the one or more servers;
a wireless router coupled to the network; and
a computer readable media encoding instructions for a method of providing sponsored internet access, said method comprising the steps of:
allowing a user to connect to the network through the wireless router;
receiving a request from a user to access a domain;
verifying the domain is a sponsored domain; and
allowing a user to access the sponsored domain.

2. The system for providing sponsored internet access of claim 1 wherein a list of sponsored domains is stored on the central repository.

3. The system for providing sponsored internet access of claim 2 wherein the sponsored domains have a prefix associated with a toll-free telephone number.

4. A method for providing sponsored internet access over a computer network comprising the steps of:
allowing a user to connect to a network through a wireless router;
receiving a request from a user to access a domain;
verifying the domain is a sponsored domain; and
allowing a user to access the sponsored domain.

5. The method for providing sponsored internet access over a computer network of claim 4 wherein a list of sponsored domains is stored on a central repository.

6. The method for providing sponsored internet access over a computer network of claim 5 wherein the sponsored domains have a prefix associated with a toll-free telephone number.
